(19) United States
(12) Patent Application Publication
(10) Pub. No.: US 2017/0204994 A1
(43) Pub. Date: Jul. 20, 2017

(54) Tube Suspension Apparatus and Insert

(71) Applicant: James J. Reed, Hixson, TN (US)

(72) Inventor: James J. Reed, Hixson, TN (US)

(21) Appl. No.: 14/996,278

(22) Filed: Jan. 15, 2016

(51) Int. Cl. F16L 3/22; F16L 3/10

(52) U.S. Cl. CPC F16L 3/222; F16L 3/1091

(57) ABSTRACT

A tube suspension apparatus is disclosed for suspending one or more tubes from an overhead structure. The apparatus includes a connection member including a tubular member having a bore therethrough wherein an elongate metal piece extends through the bore such that the connection member is connected to a tube clamp, and an attachment member extending perpendicular to the tubular member wherein the attachment member includes a connection device configured to connect to an overhead stationary structure.

### FIELD

This disclosure relates to the field of tube clamps. More particularly, this disclosure relates to an apparatus for hanging one or more tube clamps from an overhead structure.

### BACKGROUND

In various industrial sectors, tubes carrying fluid are often grouped together in parallel fashion using clamps or other devices. The number and sizes of tubes vary significantly from one industrial application to another, so there is no uniform template useful for clamping tubes that can be used and repeated at multiple sites.

U.S. Pat. No. 3,180,598 entitled “Tube Clamps” to Girard attempts to solve this problem by providing a design for tube clamps such that a first clamp can be combined with other similarly shaped tube clamps into a single structure. Each respective tube clamp of Girard's design can be configured for a different sized tube as shown for example in FIG. 1. In this way, a unique combination of tube clamps can be combined together into a single structure for a specific and unique set of parallel tubes of varying sizes. The apparatus described in Girard is configured to fasten tubes directly and horizontally to a stationary structure as shown in FIG. 1.

It is often desirable and sometimes necessary to hang fluid-carrying tubes from an overhead structure to keep them from touching a ground surface or to keep them out of the way, away from a working area. U.S. Pat. No. 7,331,549 entitled “Pipe Brackets and Pipe Hanging System” to Wirth et al. describes how conventional plumbing and piping systems are often hung from an overhead structure using, for example, U-shaped brackets, and offers a solution for hanging pipes that change diameter along their length. Wirth does not, however, provide a solution for hanging sets of parallel tubes of varying sizes from an overhead structure.

What is needed, therefore, is an apparatus configured to hang sets of parallel tubes from an overhead structure that can accommodate different combinations of tubes of varying sizes.

### SUMMARY

The above and other needs are met by an apparatus for hanging one or more tube clamps to an overhead structure. The new apparatus improves on a previous tube clamp apparatus described in U.S. Pat. No. 3,180,598 entitled “Tube Clamps” to Girard, the entirety of which is incorporated herein by reference. In combination with an apparatus for fastening one or more tubes to a stationary structure of the type wherein the device includes (a) a rigid block having spaced opposite faces for connecting respectively toward and away from said structure, (b) said block having formed in one of said faces at least one transverse recess for receiving at least a portion of said tube, (c) said block having at each end thereof a rigid lug of height less than the distance between said faces and extending longitudinally therefrom, (1) said lugs having holes extending therethrough perpendicularly to said faces, and (2) the lugs at the opposite ends of the block being staggered in relation with one lug adjacent to one of said faces and the other lug adjacent to the other face, the combined height of said lugs being not more than the distance between said faces, whereby the lug at one end can be disposed in overlapping relation to the lug at the other end of a terminally juxtaposed block of like shape with the holes of the overlapping lugs in alignment, (d) said block having a bolt extending through one of the holes along a first end of the rigid block, the improvement which comprises (e) a connection member including a tubular member having a bore therethrough wherein the bolt extends through the bore such that the connection member is connected to the rigid block, and (f) an attachment member extending substantially perpendicular to the tubular member wherein the attachment member includes a connection device configured to connect to a stationary structure. The attachment member may further comprise an elongate tube comprising an internal bore that is at least partially threaded or an elongate rod that is at least partially threaded. Preferably, the elongate tube comprises an elongate nut comprising a polygonal-shaped exterior.

In another aspect, embodiments of the disclosure provide a tube suspension apparatus for fastening one or more tubes to an overhead stationary structure, the tube suspension device comprising a first rigid block comprising a first piece, wherein at least the first piece includes a transverse recess for receiving at least a portion of one or more tubes, the first rigid block comprising a first lug with a first hole and a second lug with a second hole wherein the holes are in alignment with each other; an elongate piece extending through the first hole and the second hole; a connection member comprising a tubular member having a bore therethrough wherein the elongate piece extends through the bore such that the connection member is connected to the first rigid block, and an attachment member extending perpendicular to the tubular member wherein the attachment member includes a connection device configured to connect to a stationary structure. The attachment member may further comprise an elongate tube comprising an internal bore that is at least partially threaded or an elongate rod that is at least partially threaded. Preferably, the elongate tube comprises an elongate nut comprising a polygonal-shaped exterior. The elongate piece preferably comprises a bolt. The first rigid block may further comprise a second piece comprising a transverse recess for receiving at least a portion of one or more tubes, the second piece further comprising the second lug and the second hole.

The apparatus may further comprise a second rigid block comprising a third piece, wherein at least the third piece includes a transverse recess for receiving at least a portion of a tube, the second rigid block comprising a third lug with a third hole and a fourth lug with a fourth hole wherein the first hole, the second hole, the third hole and the fourth hole are in alignment with each other; and the elongate piece extending through the first hole, the second hole, the third hole, the fourth hole and the bore such that the connection member is connected to the first rigid block and the second rigid block. The second rigid block may further comprise a fourth piece comprising a transverse recess for receiving at least a portion of one or more tubes, the fourth piece further comprising the fourth lug and the fourth hole.

In yet another aspect, embodiments of the disclosure provide an attachment device (or tube suspension insert) for attaching a tube clamp to an overhead stationary structure, the 105 attachment device comprising a connection member comprising a tubular member having a bore therethrough, and an attachment member extending perpendicular to the tubular member wherein the attachment member includes a connection device configured to connect to a stationary structure. The attachment member may further comprise an elongate tube comprising an internal bore that is at least partially threaded or an elongate rod that is at least partially threaded. Preferably, the elongate tube comprises an elongate nut comprising a polygonal-shaped exterior.

The previously described embodiments of the present disclosure have important advantages, including taking the advantages from the apparatus described in U.S. Pat. No. 3,180,598 to Girard and improving upon the device by creating a way to hang the tube clamp described therein from an overhead structure.

Another advantage from the embodiments described herein is that the tube suspension insert described herein supplements tube clamping devices that are already in use. As such, there is no need to purchase an entirely new tube clamp in order to hang tubes from an overhead structure.

A further advantage is that the tube suspension insert described herein can be combined with a wide range of tube clamp cluster configurations so long as there is a substantially centralized bolt or other elongate structure to which the tube suspension insert can be connected. If a particularly long cluster of parallel tube clamps is desired to be hung, more than one tube suspension insert can be used to hold up the structure.

The summary provided herein is intended to provide examples of particular disclosed embodiments and is not intended to cover all potential embodiments or combinations of embodiments. Therefore, this summary is not intended to limit the scope of the invention disclosure in any way, a function which is reserved for the appended claims.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a prior art version of a set of tube clamps combined together and connected to a horizontal surface;

FIG. 2 shows a perspective view of two pieces that form the bulk of a particular type of tube clamp;

FIG. 3 shows a side view of a piece of a tube clamp and its geometric features;

FIG. 4 shows a plan view of the piece shown in FIG. 3;

FIG. 5 shows a first end view of the piece shown in FIGS. 3 and 4;

FIG. 6 shows a second end view of the piece shown in FIGS. 3-5;

FIG. 7 shows a perspective view of a tube suspension insert;

FIG. 8 shows a side view of the tube suspension insert shown in FIG. 7;

FIG. 9 shows an end view of the tube suspension insert shown in FIGS. 7 and 8;

FIG. 10 shows a first perspective view of an embodiment of a tube suspension apparatus including a tube suspension insert and a single tube clamp;

FIG. 11 shows a second perspective view of the tube suspension apparatus shown in FIG. 10;

FIG. 12 shows a front view of a tube suspension apparatus including three tube clamps oriented in serial fashion vertically and a tube suspension insert connecting the clamps to an overhead structure;

FIG. 13 shows a perspective view of a tube suspension apparatus including two tube clamps connected in parallel and a tube suspension insert;

FIG. 14 shows a front view of a tube suspension apparatus including four tube clamps connected together in parallel and a tube suspension insert connecting the tube clamps to an overhead structure; and

FIG. 15 shows a front view of a tube suspension apparatus including four tube clamps connected together in a 2×2 cluster and a tube suspension insert connecting the tube clamps to an overhead structure.

The figures are provided to illustrate concepts of the invention disclosure and are not intended to embody all potential embodiments of the invention. Therefore, the figures are not intended to limit the scope of the invention disclosure in any way, a function which is reserved for the appended claims.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Block: a solid, rigid structure. The term “block” as used herein is not intended to be limited to a particular shape.

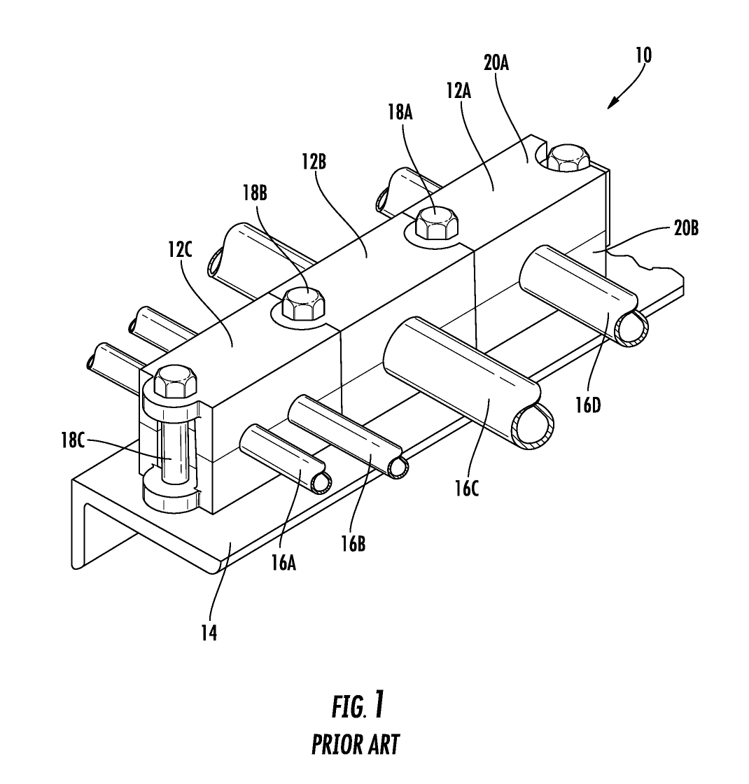

FIG. 1 shows a prior art embodiment of a tube clamp apparatus 10 wherein a plurality of tube clamps (12A, 12B, and 12C) are connected together in a parallel horizontal orientation to a stationary structure 14 beneath the apparatus 10. A plurality of tubes (16A, 16B, 16C, 16D) of various sizes are shown being clamped to the structure 14. A bolt 18C is shown holding portions of tube clamp 12C together and to the structure 14 underneath. Bolts 18B and 18A are shown perform the additional function of holding adjacent tube clamps together.

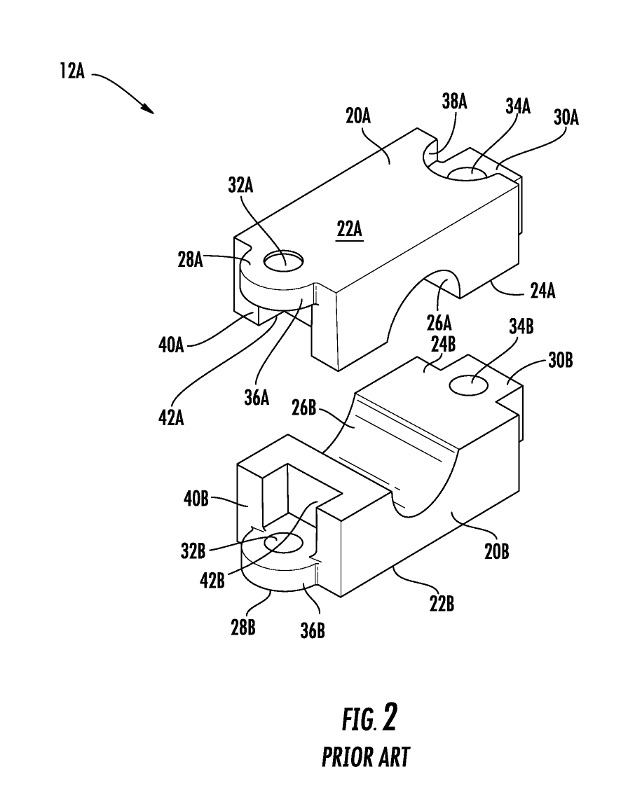

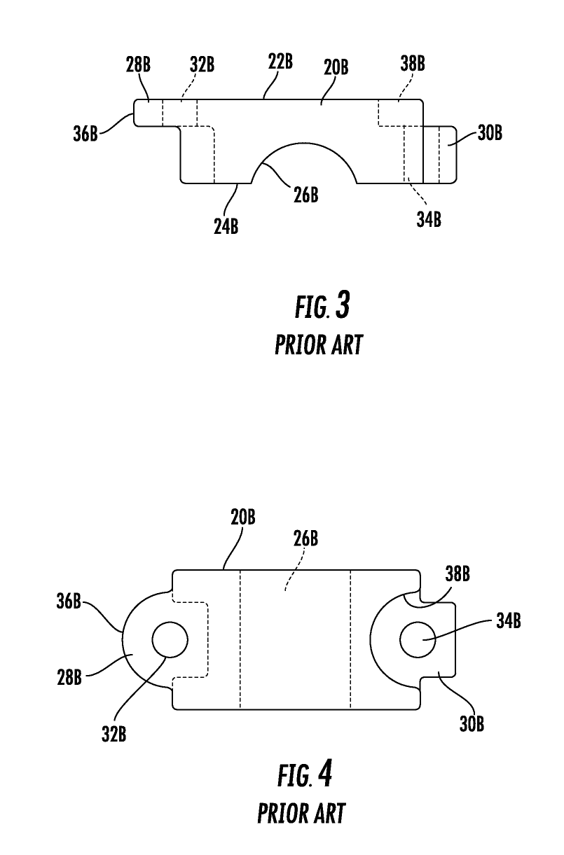

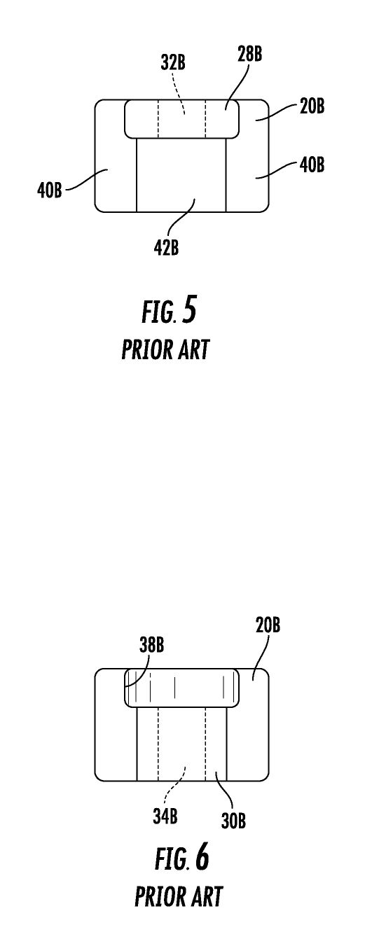

FIG. 2 shows a perspective view of tube clamp 12A separated into a first block 20A and a second block 20B. The first block 20A and the second block 20B are substantially identical. FIGS. 3-6 show additional views of parts of tube clamp 12A. The first block 20A includes an outer face 22A and an inner face 24A. In the embodiment shown in FIG. 2, the outer face 22A happens to be flat but may be in a different configuration in other embodiments. The inner face 24A includes a transverse recess 26A having a cylindrical surface.

The first block 20A includes a first lug 28A and a second lug 30A including a first aperture 32A and a second aperture 34A, respectively. The first lug 28A is curved convexly at its end 36A. A side recess 38A is located at the end proximate the second lug 30A wherein the recess 38A is shaped to receive a lug 28A from an adjacent block of the same design. At the other side of the block 20A near the first lug 28A there is a pair of laterally spaced projections 40A which define an open recess 42A shaped to receive a lug 30A from an adjacent block of the same design. As such, lug 28A is configured to engage with recess 38A of an adjacent block of the same design. Lug 30A is configured to engage with recess 42A of an adjacent block of the same design. This allows for the interlocking of various blocks together wherein adjacent blocks share the same bolt.

FIG. 2 includes features of the second block 20B that are substantially identical to the same numbered features in the first block 20A. Such features include outer face 22B, inner face 24B, transverse recess 26B, first lug 28B, second lug 30B, first aperture 32B, second aperture 34B, end 36B, recess 38B, projections 40B, and open recess 42B.

Bolts 18 are preferably used to hold the tube clamps 12 together and the bolts are placed through the apertures 32 and 34. For the example shown in FIG. 1, bolt 18A is not only used to hold the first block 20A and the second block 20B together; it is also used to secure the tube clamping apparatus 10 to a stationary structure 14 beneath the tube clamping apparatus 10.

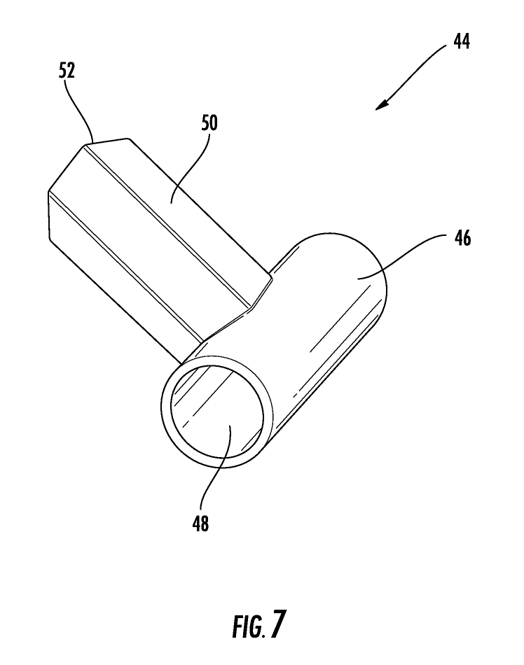

In order to suspend the tube clamping apparatus 10 from an overhead structure, additional novel features are necessary. FIG. 7 shows an embodiment of a tube suspension insert 44 configured to connect a tube clamping apparatus like those described herein to an overhead structure. The insert 44 includes a tubular member 46 having a bore 48 therethrough, and an attachment member 50 extending perpendicular to the tubular member 46 wherein the attachment member 50 includes a connection device 52 configured to connect to a stationary overhead structure. In one embodiment, the tubular member 46 is welded to the attachment member 50. In a different embodiment, the tubular member 46 and the attachment member 50 are made as a single structure through a die casting process or other similar process such as blow molding in the event the apparatus is made of polymer-based compounds.

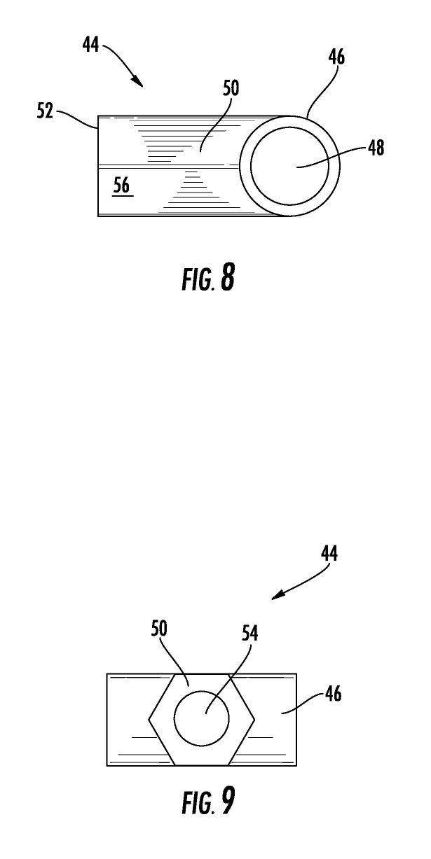

The attachment member 50 can be a variety of different fastening structures. In the embodiment shown in FIGS. 7-9, the attachment member 50 is in the form of an elongate cylindrical structure including a bore 54 extending at least partially inside the structure lengthwise. At least a portion of the internal surface inside of the bore 54 is threaded so that the attachment member can be attached to a vertically hanging threaded rod. At least a portion of the outer surface 56 of the attachment member is preferably multifaceted in a hexagonal or other polygonal shape to facilitate using a wrench or other tool to rotate the attachment member 50 when installing the attachment member 50 to an overhead structure.

In a different embodiment, the attachment member 50 itself is at least partially in the form of a threaded rod that can engage with a female threaded fastener hanging from an overhead structure. The attachment member 50 may come in other variations that employ other fastening means wherein the attachment member 50 extends substantially perpendicular to the tubular member 46 and connects with an overhead structure or other fastener.

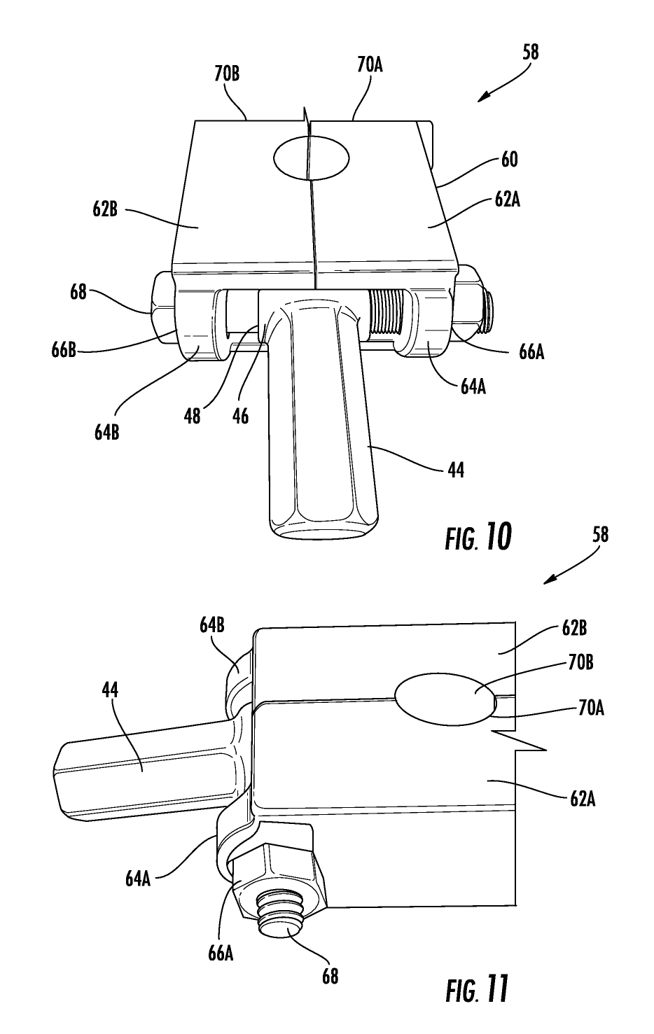

FIGS. 10 and 11 show an embodiment of a tube suspension apparatus 58 including a tube clamp 60 substantially identical to tube clamp 12A. The tube clamp 60 includes a first block 62A and a second block 62B. The blocks include first lugs 64A and 64B, and first apertures 66A and 66B, respectively. An elongate piece 68, preferably a bolt, extends through apertures 66A and 66B holding the first block 62A and the second block 62B together. The first block 62A includes a first transverse recess 70A and the second block 62B includes a second transverse recess 70B wherein the recesses together from a substantially circular void between the first block 62A and the second block 62B where a tube would be located during use of the tube suspension apparatus 58.

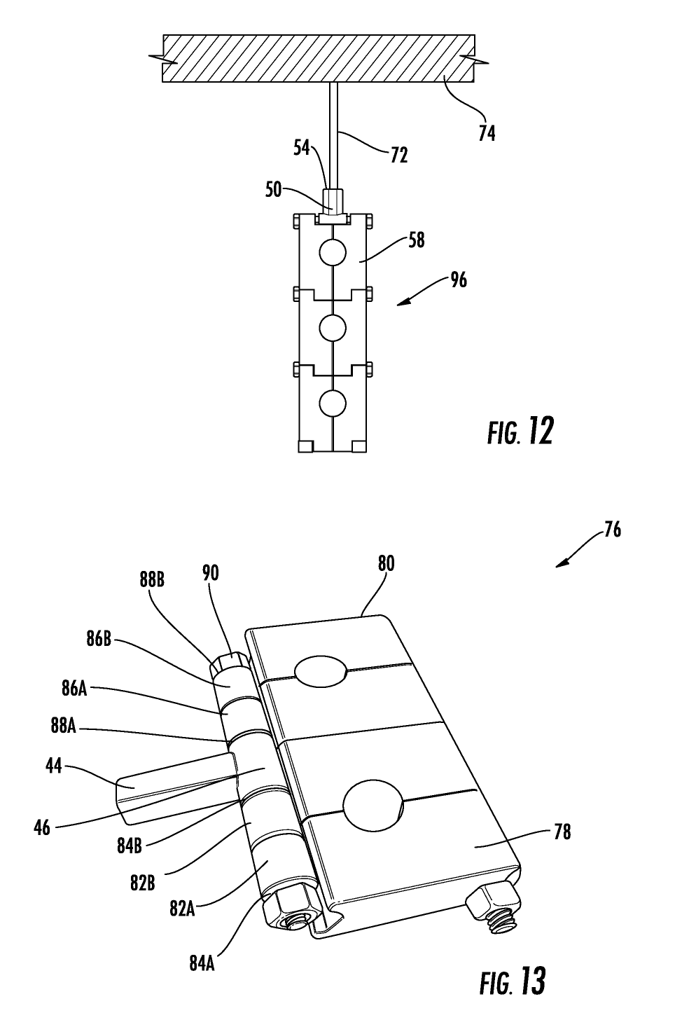

The tube suspension insert 44 from FIGS. 7-9 is shown in FIGS. 10 and 11. The elongate piece 68 extends through the bore 48 of the tubular member 46 such that the tubular member 46 is situated between the first lugs 64A and 64B. As such, the tube suspension insert 44 coupled with the tube clamp 60 forms a hinge joint. Because the tube suspension insert 44 is coupled to the tube clamp 60, the tube clamp 60 can be hung as shown in FIG. 12. In FIG. 12, a threaded rod 72 extends down from an overhead structure 74. The tube suspension apparatus 58 is attached to the threaded rod 72 via the threaded bore 54 of the attachment member 50.

FIG. 13 shows an embodiment of a tube suspension apparatus 76 including a first tube clamp 78 and a second tube clamp 80 connected adjacent to one another. Each of the tube clamps 78 and 80 are substantially identical to tube clamp 12A. The first tube clamp 78 includes lugs 82A and 82B including apertures 84A and 84B, respectively. The second tube clamp includes lugs 86A and 86B that include apertures 88A and 88B, respectively. An elongate piece 90, preferably a bolt, extends through the apertures 84A, 84B, 88A and 88B.

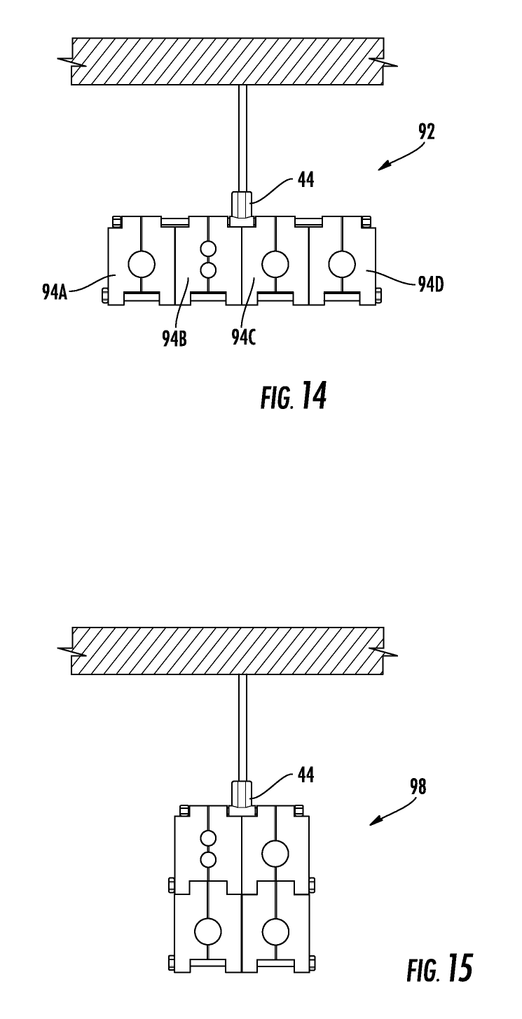

The tube suspension insert 44 from FIGS. 7-9 is shown in FIG. 13. The tubular member 46 is situated in a space between lug 82B of the first tube clamp 78 and lug 86A of the second tube clamp 80. The elongate piece 90 also extends through the bore 48 of the tubular member 46, thereby forming a hinge joint and connecting the tube suspension insert 44 to the first tube clamp 78 and the second tube clamp 80. The tube suspension apparatus 76 can then be hung from an overhead structure as shown, for example, in FIG. 14 showing a tube suspension apparatus 92 including four tube clamps (94A, 94B, 94C, and 94D) connected in parallel.

The tubular member 46 is therefore configured to fit between lugs 28A and 28B of tube clamp 12A shown in FIGS. 1 and 2 as well as between lugs 82B and 86A of adjacent tube clamps 78 and 80 as shown in FIGS. 13-15. The relative size and shape of the tubular member 46 is important because it must be able to fit in these specifically defined spaces between lugs along the end of a single tube clamp as shown in FIGS. 10-12 or between lugs of two adjacent tube clamps as shown in FIGS. 13-15. Because of its design, the tube suspension insert 44 can be used to hang a vertical cluster of tube clamps 96 joined together in serial form as shown in FIG. 12. Alternatively, the tube suspension insert 44 can be used to hang a parallel cluster of tube clamps 92 as shown in FIG. 14. Additionally, the tube suspension insert 44 can be used to hang a horizontal and vertical oriented cluster of tube clamps 98 as shown in FIG. 15. If a particularly long cluster of parallel tube clamps is desired to be hung, more than one tube suspension insert 44 can be used to hold up the structure. Various combinations of connected tube clamps are contemplated using the tube suspension insert 44 to hang such tube clamps from an overhead structure.

The various devices described herein are preferably made of metal or a metal alloy, but can also be made of other materials such as polymer-based compounds or naturally occurring material such as wood.

The previously described embodiments of the present disclosure have important advantages, including taking the advantages from the apparatus described in U.S. Pat. No. 3,180,598 to Girard and improving upon the device by creating a way to hang the tube clamp described therein from an overhead structure. Another advantage is that the tube suspension insert described herein supplements tube clamping devices that are already in use. As such, there is no need to purchase an entirely new tube clamp in order to hang tubes from an overhead structure. A further advantage is that the tube suspension insert described herein can be combined with a wide range of tube clamp cluster configurations as shown, for example, in FIGS. 12, 14 and 15 so long as there is a substantially centralized bolt or other elongate structure to which the tube suspension insert can be connected.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. In combination with an apparatus for fastening one or more tubes to a stationary structure of the type wherein the device includes (a) a rigid block having spaced opposite faces for connecting respectively toward and away from said structure, (b) said block having formed in one of said faces at least one transverse recess for receiving at least a portion of said tube, (c) said block having at each end thereof a rigid lug of height less than the distance between said faces and extending longitudinally therefrom, (1) said lugs having holes extending therethrough perpendicularly to said faces, and (2) the lugs at the opposite ends of the block being staggered in relation with one lug adjacent to one of said faces and the other lug adjacent to the other face, the combined height of said lugs being not more than the distance between said faces, whereby the lug at one end can be disposed in overlapping relation to the lug at the other end of a terminally juxtaposed block of like shape with the holes of the overlapping lugs in alignment, (d) said block having a bolt extending through one of the holes along a first end of the rigid block, the improvement which comprises: (e) a connection member including a tubular member having a bore therethrough wherein the bolt extends through the bore such that the connection member is connected to the rigid block, and (f) an attachment member extending substantially perpendicular to the tubular member wherein the attachment member includes a connection device configured to connect to a stationary structure.

2. The apparatus of claim 1 wherein the attachment member further comprises a member selected from the group consisting of an elongate tube comprising an internal bore that is at least partially threaded and an elongate rod that is at least partially threaded.

3. The apparatus of claim 2 wherein the elongate tube comprises an elongate nut comprising a polygonal-shaped exterior.

4. A tube suspension apparatus for fastening one or more tubes to an overhead stationary structure, the tube suspension device comprising: a first rigid block comprising a first piece, wherein at least the first piece includes a transverse recess for receiving at least a portion of one or more tubes, the first rigid block comprising a first lug with a first hole and a second lug with a second hole wherein the holes are in alignment with each other; an elongate piece extending through the first hole and the second hole; a connection member comprising a tubular member having a bore therethrough wherein the elongate piece extends through the bore such that the connection member is connected to the first rigid block, and an attachment member extending perpendicular to the tubular member wherein the attachment member includes a connection device configured to connect to a stationary structure.

5. The apparatus of claim 4 wherein the attachment member further comprises a member selected from the group consisting of an elongate tube comprising an internal bore that is at least partially threaded and an elongate rod that is at least partially threaded.

6. The apparatus of claim 5 wherein the elongate tube comprises an elongate nut comprising a polygonal-shaped exterior.

7. The apparatus of claim 4 wherein the first rigid block further comprises a second piece comprising a transverse recess for receiving at least a portion of one or more tubes, the second piece further comprising the second lug and the second hole.

8. The apparatus of claim 4 wherein the elongate piece comprises a bolt.

9. The apparatus of claim 4 further comprising a second rigid block comprising a third piece, wherein at least the third piece includes a transverse recess for receiving at least a portion of a tube, the second rigid block comprising a third lug with a third hole and a fourth lug with a fourth hole wherein the first hole, the second hole, the third hole and the fourth hole are in alignment with each other; and the elongate metal piece extending through the first hole, the second hole, the third hole, the fourth hole and the bore such that the connection member is connected to the first rigid block and the second rigid block.

10. The apparatus of claim 9 wherein the second rigid block further comprises a fourth piece comprising a transverse recess for receiving at least a portion of one or more tubes, the fourth piece further comprising the fourth lug and the fourth hole.

11. An attachment device for attaching a tube clamp to an overhead stationary structure, the attachment device comprising a connection member comprising a tubular member having a bore therethrough, and an attachment member extending perpendicular to the tubular member wherein the attachment member includes a connection device configured to connect to a stationary structure.

12. The apparatus of claim 11 wherein the attachment member further comprises a member selected from the group consisting of an elongate tube comprising an internal bore that is at least partially threaded and an elongate rod that is at least partially threaded.

13. The apparatus of claim 12 wherein the elongate tube comprises an elongate nut comprising a polygonal-shaped exterior.
